(19) United States
(12) Patent Application Publication
(10) Pub. No.: US 2013/0073162 A1
(43) Pub. Date: Mar. 21, 2013

(54) SENSING VEHICLE WHEEL SPEED USING IN-WHEEL MOTOR

(71) Applicant: Hyung Jin Kim, Hwaseong (KR)

(72) Inventor: Hyung Jin Kim, Hwaseong (KR)

(73) Assignee: Hyundai Motor Company, Seoul (KR)

(21) Appl. No.: 13/312,440

(22) Filed: Dec. 6, 2011

(30) Foreign Application Priority Data
Sep. 20, 2011 (KR) 10-2011-0094490

(51) Int. Cl. G06F 19/00; B60T 17/00

(52) U.S. Cl. 701/70; 180/65.275; 903/902

(57) ABSTRACT

The present invention provides a device and method for sensing a wheel speed using an in-wheel motor for a vehicle, in which a wheel speed sensor is replaced with a resolver of an in-wheel motor for driving a vehicle such as an environmentally friendly vehicle. To this end, the present invention provides a device for sensing a wheel speed using an in-wheel motor for a vehicle, the device including: a resolver of a drive motor connected to an axle and mounted in a wheel; an inverter for receiving motor speed information sensed by the resolver and converting the motor speed information into wheel speed information; and a control unit for receiving the wheel speed information from the inverter and controlling an operating component based on the wheel speed information, and a method for the same.

### CROSS-REFERENCE TO RELATED APPLICATIONS

This application claims under 35 U.S.C. §119(a) priority to Korean Application No. 10-2011-0094490, filed on Sep. 20, 2011, the disclosure of which is incorporated herein by reference in its entirety.

### BACKGROUND

(a) Technical Field

The present invention relates to a device and method for sensing a wheel speed using an in-wheel motor for a vehicle. More particularly, it relates to a device and method for sensing a wheel speed using an in-wheel motor for a vehicle, in which a wheel speed sensor is replaced with a resolver of an in-wheel motor for driving a vehicle, such as an environmentally friendly vehicle.

(b) Background Art

As well known in the art, a vehicle anti-lock brake system (ABS) is a kind of safety device that detects a change in speed of a rotating wheel during emergency braking and prevents lock-up of the wheel (in a state where the wheels are completely stopped while the vehicle is still moving).

Moreover, a vehicle electronic stability control (ESC) is a device that controls the posture of the vehicle by detecting a vehicle speed, a steering angle, a lateral acceleration, a yaw rate, etc., and controlling a braking hydraulic pressure for each wheel, thereby preventing the vehicle from swaying back and forth while turning.

As shown in FIG. 5, the ABS and ESC include a pulse ring 30 assembled to an axle and a wheel speed sensor 32 mounted adjacent to the outer circumference of the pulse ring 30.

The pulse ring 30 has a structure in which a plurality of grooves are formed at regular intervals on the outer circumference, and the wheel speed sensor 32 serves to detect a difference in the depth of the grooves of the pulse ring 30 rotating together with the axle.

Accordingly, when the pulse ring rotates together with the axle, the wheel speed sensor detects the different in the depth of the grooves formed on the pulse ring and transmits the detected signal to a control unit such as a brake control unit or a vehicle control unit. Then, the braking hydraulic pressure supplied from a master cylinder to a wheel cylinder of each wheel is controlled by a control signal of the control unit to provide braking.

The ABS and ESC are also mounted in environmentally friendly vehicles such as hybrid vehicles, electric vehicles, fuel cell vehicles, etc.

Meanwhile, as shown in FIGS. 4A and 4B, an in-wheel module including a drive motor for driving the environmentally friendly vehicle is commonly assembled to the axle.

The configuration of the in-wheel module will now be described with reference to FIG. 4A. The in-wheel module comprises a drive motor 10 having a resolver 12 assembled to an axle, a decelerator 14 connected to an output side of the drive motor 10, a hub 16 connecting the decelerator 14 to a wheel 20, and an in-wheel drum brake 18 assembled between the hub 16 and the wheel 20.

For reference, the drive motor 10 is located inside the wheel 10 and thus is also called an in-wheel motor.

As the in-wheel module including the drive motor is assembled in the wheel, an independent drive of each wheel can be achieved by the drive motor, and the torque of each wheel can be independently controlled, thereby improving the vehicle performance.

However, the ABS and ESC are further provided in the environmentally friendly vehicle in addition to the in-wheel module, which thus causes an increase in the manufacturing cost. In particular, since the components of the in-wheel module are densely mounted between the axle and the wheel, it is very difficult to provide a space for accommodating the pulse ring, the wheel speed sensor, etc., which constitute the ABS and ESC.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a device and method for sensing a wheel speed using an in-wheel motor for a vehicle, in which a wheel speed sensor for ABS and ESC is replaced with a resolver of a drive motor, which constitutes an in-wheel module, to reduce the manufacturing cost by eliminating the wheel speed sensor and to provide an installation space for components of the in-wheel module.

In one aspect, the present invention provides a device for sensing a wheel speed using an in-wheel motor for a vehicle, the device comprising: a resolver of a drive motor connected to an axle and mounted in a wheel; an inverter for receiving motor speed information sensed by the resolver and converting the motor speed information into wheel speed information; and a control unit for receiving the wheel speed information from the inverter and controlling an operating component based on the wheel speed information.

In an exemplary embodiment, the inverter may comprise a wheel speed output circuit for calculating a wheel speed based on a motor speed.

In another aspect, the present invention provides a method for sensing a wheel speed using an in-wheel motor for a vehicle, the method comprising: sensing, at a resolver of a drive motor, a motor speed by detecting the position of a rotor; receiving, at an inverter, motor speed information from the resolver, converting the motor speed information into wheel speed information, and outputting the wheel speed information to a control unit; and receiving, at the control unit, the wheel speed information from the inverter and controlling an operating component based on the wheel speed information.

In an exemplary embodiment, logic for calculating a wheel speed by multiplying the motor speed from the resolver and a deceleration ratio of a decelerator together may be directly performed by the inverter.

In another exemplary embodiment, the wheel speed information calculated by the inverter may be output to the control unit through a controller area network (CAN) communication.

In still another exemplary embodiment, the logic for calculating a wheel speed by multiplying the motor speed from the resolver and a deceleration ratio of a decelerator together may be performed by a wheel speed output circuit separately provided in the inverter.

In yet another exemplary embodiment, the wheel speed information calculated by the inverter may be output to the control unit through an analog signal.

In still yet another exemplary embodiment, the wheel speed information may be output to the control unit through pulse width modulation (PWM) duty ratio control by the wheel speed output circuit of the inverter.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram illustrating a device and method for sensing a wheel speed using an in-wheel motor for a vehicle in accordance with an exemplary embodiment of the present invention;

FIG. 2 is a schematic diagram illustrating a device and method for sensing a wheel speed using an in-wheel motor for a vehicle in accordance with another exemplary embodiment of the present invention;

FIG. 3 is a schematic diagram illustrating the sensing operation of a resolver of an in-wheel motor;

FIGS. 4A and 4B are schematic diagrams illustrating the configuration of an in-wheel module including an in-wheel motor; and

FIG. 5 is a schematic diagram illustrating a wheel speed sensor for ABS and ESC.

Reference numerals set forth in the Drawings includes reference to the following elements as further discussed below:

10: drive motor;

12: resolver;

14: decelerator;

16: hub;

18: drum brake;

20: wheel;

30: pulse ring; and

32: wheel speed sensor.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In addition, it is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The present invention is characterized in that a wheel speed sensor for ABS and ESC is replaced with a resolver of a drive motor which constitutes an in-wheel module of a vehicle, such as a hybrid vehicle, electric vehicle, fuel cell vehicle, etc. (e.g., an “environmentally friendly vehicle”).

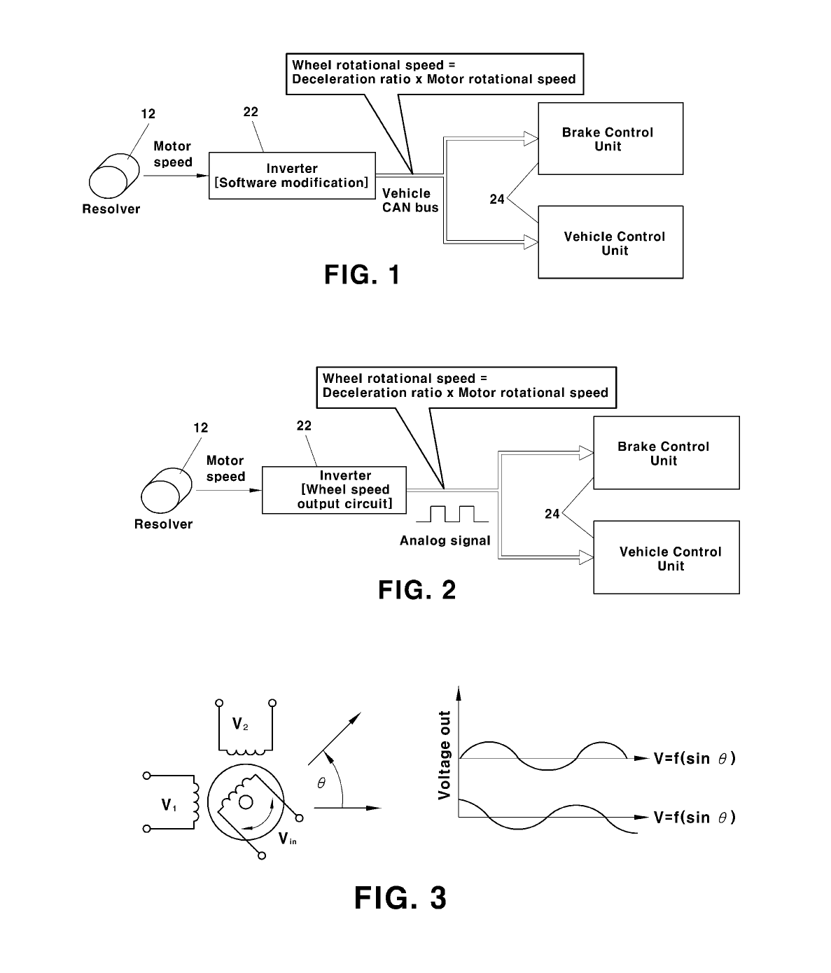

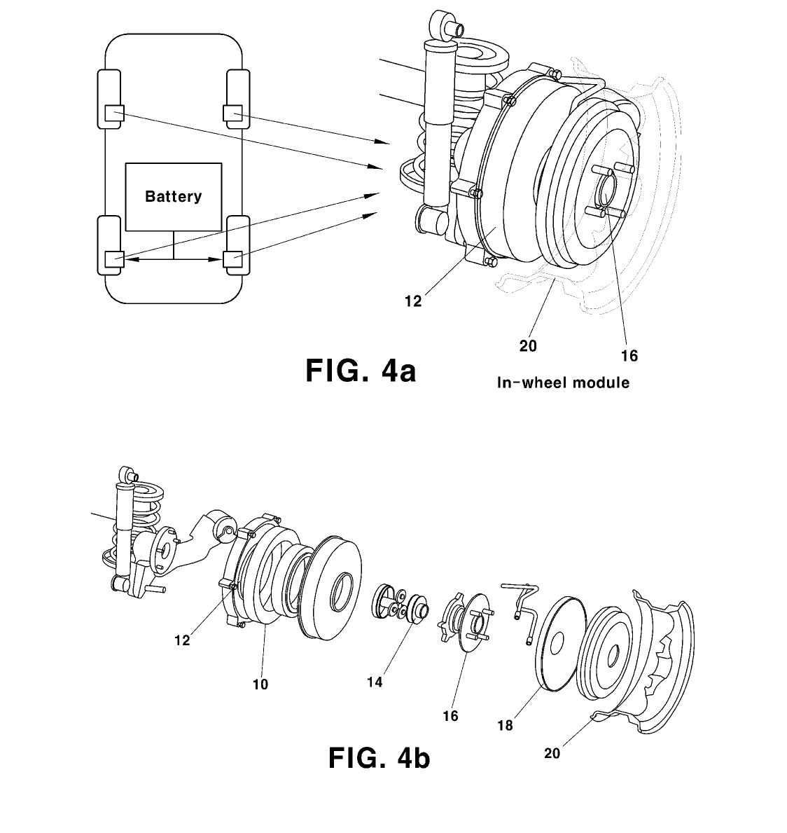

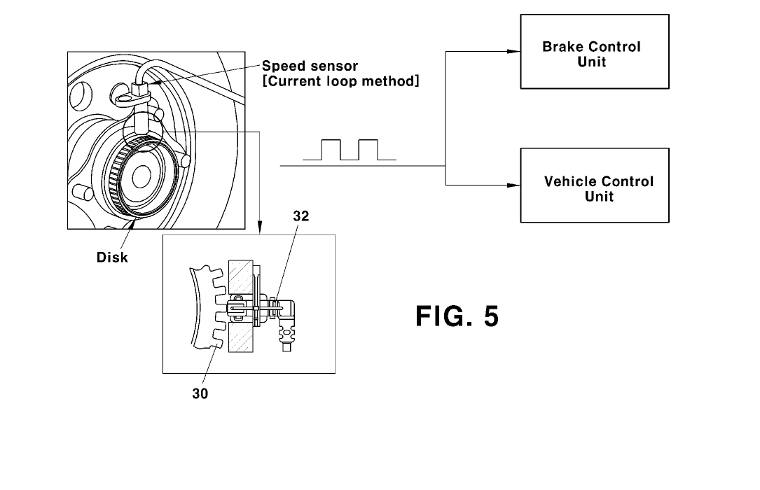

To this end, as shown in FIG. 1 and/or FIG. 2, a device for sensing a wheel speed using an in-wheel motor comprises a resolver 12 of a drive motor connected to an axle and mounted in a wheel, an inverter 23 for receiving motor speed information sensed by the resolver and converting the motor speed information into wheel speed information, and a control unit 24 for receiving the wheel speed information from the inverter and controlling an operating component based on the wheel speed information.

The resolver is a kind of transformer for controlling the transformation ratio based on the position of a rotor and serves as a position sensor that detects the position of a motor rotor.

For vector control of the drive motor used in the illustrative vehicle, a motor control unit should establish a coordinate system in synchronization with the flux position, and thus the resolver functions to detect an absolute position of a motor rotor so as to establish the coordinate system.

The rotor position detection process of the resolver will be described with reference to FIG. 3 below. First, when the rotor rotates in a state where an excitation voltage Vᵢₙ with a constant magnitude and frequency is applied to a first wiring (input side) of the resolver, the magnetic coupling coefficient is changed, and thus voltages V₁ and V₂ having different amplitudes are generated from two second wirings (output side).

Here, the voltage signals output from the two second wirings (output side) are modulated by sine and cosine functions, respectively, and thus the resolver 12 senses the position of the rotor by detecting the amplitude ratio of the sine waves and the cosine waves, thereby obtaining speed information of the drive motor. The speed information of the drive motor obtained by the resolver is provided to the motor control unit and used to generate a torque command and a speed command of the drive motor.

The inverter 22 is a driver for the drive motor and, in the present invention, the inverter may calculate and output the wheel speed based on the motor speed by modifying the software logic of the inverter or may be equipped with a separate hardware wheel speed output circuit for calculating the wheel speed based on the motor speed.

The control unit 24 such as a brake control unit or a vehicle control unit serves to control various electrical and electronic components based on the wheel speed.

Next, a method for sensing a wheel speed using an in-wheel motor of the present invention having the above-described configuration will be described.

### EXAMPLE 1

First, the in-wheel motor, i.e., the resolver of the drive motor, senses the motor speed by detecting the position of the rotor.

The resolver is a sensor with a performance about four times higher than that of an existing wheel speed sensor. As mentioned above, when the rotor rotates in a state where an excitation voltage Vᵢₙ with a constant magnitude and frequency is applied to a first wiring (input side) of the resolver, voltages V₁ and V₂ having different amplitudes are generated from two second wirings (output side). The voltage signals output from the two second wirings (output side) are modulated by sine and cosine functions, respectively, and thus the resolver senses the position of the rotor by detecting the amplitude ratio of the sine waves and the cosine waves, thereby obtaining speed information of the drive motor.

Then, the speed information of the drive motor obtained by the resolver is output to the inverter.

The inverter typically performs the logic for controlling the drive motor. However, the inverter in accordance with Example 1 of the present invention may comprise control logic for receiving the motor speed information from the resolver, converting the motor speed information into wheel speed information, and outputting the wheel speed information to the control unit.

Accordingly, the logic for calculating an actual wheel speed by multiplying the motor speed from the resolver and a deceleration ratio of a decelerator together is directly performed by the inverter and then the wheel speed information is output to the control unit.

That is, the wheel speed information calculated by the inverter is output to the control unit through a CAN communication, and thus the control unit receives the wheel speed information from the inverter and controls other operating electrical and electronic components including ABS and ESC (for example, a speedometer on a dashboard and the like) based on the wheel speed information.

### EXAMPLE 2

Like Example 1, the resolver of the drive motor senses the motor speed by detecting the position of the rotor.

As mentioned above, when the rotor rotates in a state where an excitation voltage Vᵢₙ with a constant magnitude and frequency is applied to a first wiring (input side) of the resolver, voltages V₁ and V₂ having different amplitudes are generated from two second wirings (output side). The voltage signals output from the two second wirings (output side) are modulated by sine and cosine functions, respectively, and thus the resolver senses the position of the rotor by detecting the amplitude ratio of the sine waves and the cosine waves, thereby obtaining the speed information of the drive motor.

Then, the speed information of the drive motor obtained by the resolver is output to the inverter.

The inverter in accordance with Example 2 of the present invention may be a hardware component, which receives the motor speed information from the resolver, converts the motor speed information into wheel speed information, and outputs the wheel speed information to the control unit, and may be equipped with a separate wheel speed output circuit.

Accordingly, the logic for calculating an actual wheel speed by multiplying the motor speed from the resolver and a deceleration ratio of a decelerator together is performed by the wheel speed output circuit of the inverter.

Subsequently, the wheel speed information calculated by the wheel speed output circuit of the inverter is output to the control unit through an analog signal and, preferably, the wheel speed information is output to the control unit by PWM duty ratio control.

As such, the wheel speed information calculated by the wheel speed output circuit of the inverter is output to the control, and thus the control unit controls other operating electrical and electronic components including ABS and ESC (for example, a speedometer on a dashboard and the like) based on the wheel speed information.

As described above, the present invention provides the following effects.

Since, the wheel speed information is provided to various electrical and electronic components, which require the wheel speed, such as ABS and ESC using the signal sensed by the resolver included in the drive motor of the vehicle (e.g., the environmentally friendly vehicle), it is possible to eliminate the existing components such as the wheel speed sensor, the pulse ring, etc., thereby reducing the manufacturing cost.

Moreover, although it is conventionally necessary to mount the pulse ring and the wheel speed sensor, which constitute the ABS and ESC, in the in-wheel module having a limited space, the pulse ring and the wheel speed sensor can be eliminated, which is advantageous for the package configuration of the in-wheel module.

Furthermore, when the existing wheel speed sensor is mounted and used as it is, it is possible to prepare for the case in which one of the two sensors (such as the resolver and the wheel speed sensor) fails.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A device for sensing a wheel speed of a vehicle, the device comprising:
a resolver of a drive motor connected to an axle and mounted in a wheel, the resolver configured to sense motor speed information;
an inverter configured to receive motor speed information sensed by the resolver and to convert the motor speed information into wheel speed information; and
a control unit configured to receive the wheel speed information from the inverter and to control an operating component based on the wheel speed information.

2. The device of claim 1, wherein the inverter comprises a wheel speed output circuit configured to calculate a wheel speed based on a motor speed.

3. A method for sensing a wheel speed of a vehicle, the method comprising:
sensing, at a resolver of a drive motor, a motor speed by detecting a position of a rotor;
receiving, at an inverter, motor speed information from the resolver;
converting, at the inverter, the motor speed information into wheel speed information;
outputting the wheel speed information from the inverter to a control unit;
receiving, at the control unit, the wheel speed information from the inverter;
and controlling, by the control unit, an operating component based on the wheel speed information.

4. The method of claim 3, further comprising: calculating a wheel speed by the inverter by multiplying the motor speed from the resolver and a deceleration ratio of a decelerator together.

5. The method of claim 4, further comprising: outputting the wheel speed information calculated by the inverter to the control unit through a CAN communication.

6. The method of claim 3, further comprising: outputting the wheel speed information calculated by the inverter to the control unit through a CAN communication.

7. The method of claim 3, further comprising: calculating a wheel speed by a wheel speed output circuit separately provided in the inverter by multiplying the motor speed from the resolver and a deceleration ratio of a decelerator together.

8. The method of claim 7, further comprising: outputting the wheel speed information calculated by the inverter to the control unit through an analog signal.

9. The method of claim 8, further comprising: outputting the wheel speed information to the control unit through pulse width modulation (PWM) duty ratio control by the wheel speed output circuit of the inverter.

10. The method of claim 3, further comprising: outputting the wheel speed information calculated by the inverter to the control unit through an analog signal.
